(19) United States
(12) Patent Application Publication
(10) Pub. No.: US 2024/0420023 A1
(43) Pub. Date: Dec. 19, 2024

(54) METHOD, APPARATUS, ELECTRONIC DEVICE AND STORAGE MEDIUM OF DATA LABELING

(71) Applicant: Beijing Zitiao Network Technology Co., Ltd., Beijing (CN)

(72) Inventors: Shihao REN, Beijing (CN); Min ZHANG, Beijing (CN); Jiayi CHEN, Beijing (CN)

(21) Appl. No.: 18/636,878

(22) Filed: Apr. 16, 2024

(30) Foreign Application Priority Data
Jun. 19, 2023 (CN) 202310729659.X

(51) Int. Cl. G06N 20/00

(52) U.S. Cl. CPC G06N 20/00

(57) ABSTRACT

The present disclosure provides a method, an apparatus, an electronic device and a storage medium of data labeling. In some embodiments, the method comprises: receiving a data labeling request, the data labeling request including one or more labeling tasks, one or more task types, labeling data, a constraint, one or more labeling index values; determining a target labeling task based on the one or more labeling index values and the one or more labeling tasks; determining a labeling procedure based on the data labeling request and at least one selected from a group consisting of the task type, a labeling quality, and a labeling metric; and labeling the labeling data using the labeling procedure. In certain embodiments, multiple target values, including the data labeling quality, the labeling efficiency and the labeling costs, can be dynamically balanced to achieve better resource allocation and provide an individualized labeling configuration for labeling tasks.

### FIELD

Embodiments of the present disclosure relates to the field of computer technology, and more specifically, to a method, an apparatus, an electronic device and a storage medium of data labeling.

### BACKGROUND

Data labeling refers to a process for providing annotations for data including voice, pictures, texts and videos, etc. and converting them into information identifiable by a machine learning algorithm. Through data labeling, the machine learning algorithm may have an more accurate prediction to the real-world environments and conditions.

In some use cases, the method for labeling data may include manual labeling and automatic labeling. Manual labeling refers to manually labeling the data by the labeling staff, while automatic labeling indicates that one or more machine learning model or other computing models labels the data through predicted data labels. It is to be understood that the manual labeling, although delivering high labeling quality, may require a large amount of labeling expenses and manual costs. By contrast, the automatic labeling saves labeling expenses and labor costs, but its labeling quality may be lower than the manual one. In addition, to address data security issues, different labeling requirements are put forward for various labeling tasks. In such case, different methods for labeling data are adopted. Here, the notable aspects include how to select the data labeling method and how to balance multiple objectives, including data labeling quality, labeling efficiency and labor costs, and/or the like.

Therefore, a new and/or updated data labeling method is in need to solve at least one of the above technical problems.

### SUMMARY

Embodiments of the present disclosure provide a method, an apparatus, an electronic device and a storage medium of data labeling.

In some aspects, the present disclosure provides a method of data labeling, the method comprising: receiving a data labeling request, the data labeling request including one or more labeling tasks, one or more task types corresponding to the one or more labeling tasks, labeling data, a constraint, one or more labeling index values corresponding to the one or more labeling asks, the labeling data including one or more data items, the constraint including one or more constraint conditions; determining a target labeling task based on the one or more labeling index values and the one or more labeling tasks; dividing, based on the constraint, the labeling data of the target labeling task into automatic labeling data and manual labeling data; determining a labeling procedure based on the data labeling request and at least one selected from a group consisting of the task type, a labeling quality, and a labeling metric; and labeling the automatic labeling data using the labeling procedure.

In certain aspects, the present disclosure provides an electronic device, comprising: one or more memories comprising instructions stored thereon; and one or more processors configured to execute the instructions and perform operations comprising: receiving a data labeling request, the data labeling request including one or more labeling tasks, one or more task types corresponding to the one or more labeling tasks, labeling data, a constraint, one or more labeling index values corresponding to the one or more labeling asks, the labeling data including one or more data items, the constraint including one or more constraint conditions; determining a target labeling task based on the one or more labeling index values and the one or more labeling tasks; dividing, based on the constraint, the labeling data of the target labeling task into automatic labeling data and manual labeling data; determining a labeling procedure based on at least one selected from a group consisting of the task type, a labeling quality, and a labeling metric; and labeling the automatic labeling data using the labeling procedure.

In some aspects, the present disclosure provides a non-transitory computer readable storage medium stored instructions thereon, the instructions, when executed by one or more processors, cause the one or more processors to perform operations comprising: receiving a data labeling request, the data labeling request including one or more labeling tasks, one or more task types corresponding to the one or more labeling tasks, labeling data, a constraint, one or more labeling index values corresponding to the one or more labeling asks, the labeling data including one or more data items, the constraint including one or more constraint conditions; determining a target labeling task based on the one or more labeling index values and the one or more labeling tasks; dividing, based on the constraint, the labeling data of the target labeling task into automatic labeling data and manual labeling data; determining a labeling procedure based on at least one selected from a group consisting of the task type, a labeling quality, and a labeling metric; and labeling the automatic labeling data using the labeling procedure.

Other features and advantages of the present disclosure will become apparent from the more detailed description given below. However, it should be understood that the following detailed description and specific examples, while indicating embodiments of the methods, systems, and apparatus, are given by way of illustration only, since various changes and modifications within the spirit and scope of the concepts disclosed herein will become apparent to those skilled in the art from the following detailed description.

### BRIEF DESCRIPTION OF THE DRAWINGS

Through the following detailed description of the non-restrictive embodiments with reference to the accompanying drawings, other features, objectives and advantages of the present disclosure will become more apparent. The drawings are provided only for illustrating the specific implementations, rather than restricting the present disclosure. In the drawings:

FIG. 1 illustrates a system architecture diagram of one embodiment of the data labeling system according to the present disclosure;

FIG. 2 illustrates a flowchart of an embodiment of the data labeling method according to the present disclosure;

FIG. 3 illustrates a structural diagram of one embodiment of the data labeling apparatus according to the present disclosure;

FIG. 4 illustrates a structural diagram of a computer system suitable for implementing the electronic device according to the embodiments of the present disclosure.

### DETAILED DESCRIPTION OF EMBODIMENTS

The present disclosure is further described in details below with reference to the drawings and the embodiments. It is to be appreciated that the specific embodiments described here are only for explain the related invention, rather than restricting it. It is also to be noted that the drawings only demonstrate the parts related to the invention for the sake of description.

It is to be understood that features in the embodiments and implementations of the present disclosure may be combined without causing conflicts. The present disclosure is to be described in details below with reference to the drawings and the embodiments.

Although illustrative methods may be represented by one or more drawings (e.g., flow diagrams, communication flows, etc.), the drawings should not be interpreted as implying any requirement of, or particular order among or between, various steps disclosed herein. However, some embodiments may require certain steps and/or certain orders between certain steps, as may be explicitly described herein and/or as may be understood from the nature of the steps themselves (e.g., the performance of some steps may depend on the outcome of a previous step). Additionally, a “set,” “subset,” or “group” of items (e.g., inputs, algorithms, data values, etc.) may include one or more items and, similarly, a subset or subgroup of items may include one or more items. A “plurality” means more than one.

As used herein, the term “based on” is not meant to be restrictive, but rather indicates that a determination, identification, prediction, calculation, and/or the like, is performed by using, at least, the term following “based on” as an input. For example, predicting an outcome based on a particular piece of information may additionally, or alternatively, base the same determination on another piece of information. As used herein, the term “receive” or “receiving” means obtaining from a data repository (e.g., database), from another system or service, from another software, or from another software component in a same software. In certain embodiments, the term “access” or “accessing” means retrieving data or information, and/or generating data or information.

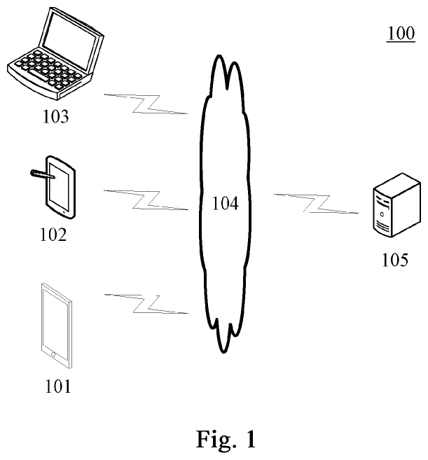

FIG. 1 illustrates an example system 100 of an embodiment, also referred to as an example system architecture 100, to which the data labeling method, apparatus, computing device and storage medium of the present disclosure may be applied.

As shown in FIG. 1, the system architecture 100 may include computing devices 101, 102 and 103, a network 104 and a server 105. The network 104 is the medium for providing communication links between the computing devices 101, 102 and 103 and the server 105. The network 104 may include various types of connections, e.g., wired, wireless communication links or optic fiber cables etc.

According to certain embodiments, the user may use the computing devices 101, 102 and 103 to interact with the server 105 via the network 104, to receive or send messages etc. The computing devices 101, 102 and 103 may be mounted with various communication client applications, e.g., data labeling applications, voice interaction applications, video conferencing applications, short video social applications, web browser applications, shopping applications, search applications, instant messaging tools, email clients, social platform software and the like.

The computing devices 101, 102 and 103 may be hardware or software. When the computing devices 101, 102 and 103 are hardware, they may be various electronic devices having microphones and speakers, including but not limited to smartphones, tablet computers, E-book readers, MP3 players (Moving Picture Experts Group Audio Layer III), MP4 players (Moving Picture Experts Group Audio Layer IV), portable computers and desktop computers etc. When the computing devices 101, 102 and 103 are software, they may be mounted in the listed electronic devices. In addition, they may be implemented as a plurality of software or software modules (e.g., for transmitting data labeling requests), or as an individual software or software module. The present disclosure is not limited to the above mentioned hardware and/or software.

The server 105 may be a server that provides various services, such as a backend server that processes data labeling requests sent by the computing devices 101, 102, and 103. The background server can perform corresponding processing based on the data labeling request sent by the computing device.

In some cases, the data labeling request method provided by the present disclosure can be executed collectively by the computing devices 101, 102, 103 and the server 105. For example, the step of “receiving a data labeling request” may be executed by the computing devices 101, 102 and 103, and the step of “determining a target labeling task based on the label index and the label index value of each labeling task” may be performed by the server 105. This disclosure is not limited in this regard. Correspondingly, the data labeling apparatus also may be provided in the computing devices 101, 102 and 103 and the server 105 respectively.

In some situations, the data labeling method provided by the present disclosure may be executed by the server 105. Correspondingly, the data labeling apparatus may also be disposed in the server 105. Here, the system architecture 100 may also be free of computing devices 101, 102 and 103.

In some cases, the data labeling method provided by the present disclosure may be executed by the computing devices 101, 102 and 103. Correspondingly, the data labeling apparatus may also be disposed in the computing devices 101, 102 and 103, where a computing device includes one or more processors. In some examples, the system architecture 100 may not comprise the server 105.

It is to be understood that the server 105 may be hardware or software. In case of being hardware, the server 105 may be implemented as a distributed server cluster consisting of a plurality of servers, or an individual server. In case of being software, the server 105 may be implemented as a plurality of software or software modules (e.g., for providing distributed services), or as an individual software or software module. The present disclosure is not limited in this regard.

It should be understood that the quantity of computing device, network and server illustrated in FIG. 1 is only exemplary. Any numbers of computing device, network and server may be provided in view of the actual requirements.

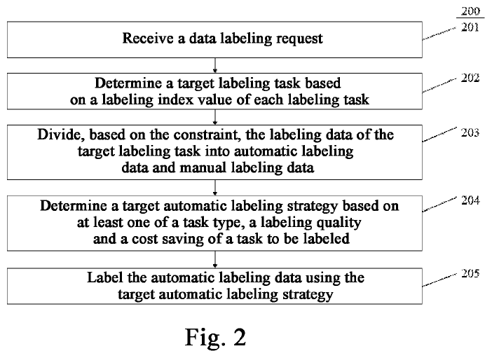

Continuing to refer to FIG. 2, which illustrates a flowchart 200 of an embodiment of the data labeling method according to the present disclosure. The data labeling method shown in FIG. 2 may be applied to the computing device or server demonstrated by FIG. 1. According to some embodiments, the flow 200 includes the following steps:

A data labeling request is received at step 201.

In some embodiments, the data labeling request includes at least one labeling task and task type, labeling data, constraints and labeling index value corresponding to each labeling task; the labeling data include at least one data item and the constraints include at least one constraint condition.

In certain embodiments, the task type of the labeling task indicates how the labeling data is labeled as required. For example, the task type of the labeling task may be selecting a target object in an image with a rectangular box. The task type of the labeling task may also be outlining the profile of the target object in the image with irregular polygons.

One data labeling request may include at least one labeling task, and different labeling tasks may correspond to the same labeling type, but have various labeling targets. For example, both the labeling task T₁ and the labeling task T₂ are to select the target object in the image with a box. Specifically, for example, the labeling task T₁ refers to selecting a human face image with a box while the labeling task T₂ indicates selecting a cat face image with a box.

In some embodiments, the labeling data is the data required to be labeled by the labeling task. The labeling data include at least one data item, e.g., the labeling data may include at least one image to be labeled.

In certain embodiments, constraints are data labeling conditions predefined by a party demanding labeling based on specific labeling tasks. For example, when the labeling task involves security issues such as user information and privacy, or a more precise user service is required, manual labeling is performed to ensure that the labeling service is safe and reliable. In some embodiments, automatic labeling is used when the safety requirements of the labeling task are low. In certain embodiments, constraints include at least one constraint condition.

According to certain embodiments, the labeling index value may include at least one of the number of unlabeled data, the expected time cost value of the labeling task and the estimated economic benefit value of the labeling task etc. In some embodiments, the specific value of the labeling index value is determined by the party demanding labeling. In certain embodiments, the labeling index value may be an aggregated value of at least one of the number of unlabeled data, the expected time cost value of the labeling task and the estimated economic benefit value of the labeling task etc. In addition, as an example, the labeling index value may be 0, which means that the labeling index value has nothing to do with the labeling task.

According to some embodiments, the labeling index value can be positively correlated with the importance of the labeling task. In certain embodiments, in the presence of a negative correlation between the labeling index value and the importance of the labeling task, the labeling index value may be reversely converted to form a new labeling index value that is positively correlated with the labeling task.

At step 202, in certain embodiments, a target labeling task is determined based on the labeling index value of each labeling task. In some embodiments, this step is performed to sort priority of at least one labeling task in the labeling request, and further obtain the labeling task with the highest priority, i.e., target labeling task.

In some optional implementations, a first number of rest labeling tasks dominated by each labeling task may be calculated in accordance with the labeling index value of each labeling task, where the rest labeling tasks indicate remaining labeling tasks after selecting any one labeling task from the at least one labeling task. In certain implementations, priority of the at least one labeling task is sorted according to the first number and a labeling task with the highest first number is determined as the target labeling task.

For example, the data labeling request received in step 201 includes N labeling tasks, i.e., T={T₁, T₂, . . . , T_{N}}; the labeling data corresponding to N labeling tasks are D={D₁, D₂, . . . , D_{N}}, where the labeling task Tᵢ corresponds to the labeling data Dᵢ, i being a positive integer between 1 to N; the labeling task Tᵢ corresponds to the labeling index of I_{T}_{ᵢ}={I_{T}_{ᵢ}¹, I_{T}_{ᵢ}², . . . , I_{T}_{ᵢ}ⁿ},
where n is a total number of the labeling index. As an example, for any two tasks Tₚ and T_{q}, where p, q∈[1,N], p≠q. For all indices in the labeling index I_{Ti}, if Tₚ has an index value identical to T_{q} and at least one index value better than T_{q}, the labeling task Tₚ dominates the labeling task T_{q}, i.e., the labeling task Tₚ is dominant, indicating a greater importance of the labeling task Tₚ than the labeling task T_{q}. A first number where each labeling task is dominant is calculated and the priority of the labeling task is sorted by the first number. The labeling task Tₘ with the highest first number is determined as the target labeling task. The target labeling task Tₘ is labeled in priority, where m is a positive integer between 1 and N.

In this step, in certain examples, a sequence for labeling the labeling tasks is determined according to the importance of the labeling tasks with reference to the Pareto dominance relation between the labeling tasks. At step 203, in some embodiments, the labeling data of the target labeling task are divided into automatic labeling data and manual labeling data based on the constraints. In certain embodiments, to determine the target labeling task, the labeling data of the target labeling task are divided into automatic labeling data and manual labeling data, where the automatic labeling data are automatically labeled by an automatic labeling procedure, also referred to as an automatic labeling strategy, and the manual labeling data are manually labeled. It is to be noted that this step may also be implemented individually, and the labeling data of any labeling task may be divided into automatic labeling data and manual labeling data. Such division is not restricted to the labeling data of the target labeling task.

In one embodiment, it is decided whether each data item in the labeling data satisfies each constraint condition of the constraints corresponding to the target labeling task respectively; if satisfied, data items of the labeling data are determined as automatic labeling data; if not satisfied, data items of the labeling data are determined as manual labeling data.

For example, in terms of the labeling data Dₘ corresponding to the target labeling task Tₘ, it is decided for each data item in the labeling data Dₘ whether the data item satisfies all conditions in the constraints C, where C={C₁, C₂, . . . , C_{nc}}, where nc denotes the number of constraint conditions in the constraints C corresponding to the labeling task Tₘ. If a data item 1 in the labeling data Dₘ satisfies all constraint conditions in the constraints C, in some examples, the data item 1 is determined as automatic labeling data Dₘ^{a}; in case a data item 2 fails to satisfy all constraint conditions in the constraints C, the data item 2 is determined as manual labeling data Dₘ^{h}.

In one embodiment, the manual labeling data usually contain some images with low visual similarity and inconsistent in product types. As such, some negatives may be automatically removed by a pre-filter procedure, also referred to as a pre-filter strategy, to find a solution that balances the prediction accuracy and labeling metric.

In some embodiments, a target pre-filter procedure is determined according to the task type of the target labeling task. Specifically, for example, a pre-filter procedure set including at least one pre-filter procedure is obtained, wherein each pre-filter procedure corresponds to a task type of a filterable labeling task, and the pre-filter procedure is provided for discarding negatives in the manual labeling data. As an example, the negatives here indicate some images with low visual similarity and inconsistent in product types in the manual labeling data.

According to certain embodiments, the task type of the target labeling task matches with the task type of the filterable labeling task corresponding to the pre-filter procedure, to determine whether the task type of the filterable labeling task corresponding to the pre-filter procedure includes the task type of the target labeling task. If yes, the pre-filter procedure corresponding to the task type of the target labeling task is determined as the target pre-filter procedure. In one embodiment, the pre-filter procedure set may be a preset pre-filter procedure set.

In some embodiments, it is decided respectively whether each data item in the manual labeling data satisfies a target pre-filter procedure threshold in accordance with the target pre-filter procedure; if satisfied, the data items are sent to a manual labeling data item queue and a labeling terminal is assigned to the data items in the manual labeling data item queue. In certain embodiments, the labeling staff would label the data items via the labeling terminal. If not satisfied, in some embodiments, the data items are determined as negatives and discarded.

At step 204, according to some embodiments, a target automatic labeling procedure is determined in accordance with at least one of task type, labeling quality and labeling metric of a task to be labeled.

In one embodiment, the task to be labeled indicates an unlabeled labeling task in the data labeling request; the labeling quality refers to the quality of data labeling; and labeling metric denotes the costs that can be saved by labeling the labeling task. The costs may include at least one of labor cost, time cost and expense cost.

Specifically, as an example, it is determined, based on the task type of the target labeling task, whether a historical automatic labeling procedure corresponding to the target labeling task is present.

In some optional implementations, a historical automatic labeling procedure set is obtained. Specifically, for example, the historical automatic labeling procedure set may be obtained directly from a database. In certain embodiments, the historical automatic labeling procedure set includes at least one historical automatic labeling procedure, wherein each of the historical automatic labeling procedure corresponds to a task type of a labelable task, and the historical automatic labeling procedure is provided for labeling the automatic labeling data.

In some embodiments, the task type of the target labeling task matches with the task type of the labelable task corresponding to the historical automatic labeling procedure.

In certain embodiments, it is determined whether the historical automatic labeling procedure corresponding to the target labeling task is present in accordance with whether the task type of the labelable task corresponding to the historical automatic labeling procedure includes the task type of the target labeling task.

In some embodiments, if it is determined that the task type of the labelable task corresponding to the historical automatic labeling procedure is never the same as the task type of the automatic labeling data, the absence of the historical automatic labeling procedure corresponding to the target labeling task is decided.

In some optional implementations, in case of the absence of the historical automatic labeling procedure corresponding to the target labeling task, the automatic labeling data are determined as the manual labeling data, i.e., the automatic labeling data are labeled manually.

If it is determined that the task type of the labelable task corresponding to the historical automatic labeling procedure is the same as the task type of the automatic labeling data, in certain implementations, the presence of the historical automatic labeling procedure corresponding to the target labeling task is decided.

In some optional implementations, if the presence of the historical automatic labeling procedure corresponding to the target labeling task is determined, the historical automatic labeling procedure is determined as a target historical automatic labeling procedure and it is decided whether the target historical automatic labeling procedure satisfies a first quality evaluation index.

In certain implementations, it is decided whether the target historical automatic labeling procedure satisfies a first quality evaluation index, i.e., it is decided whether the target historical automatic labeling procedure can satisfy the labeling requirements for the automatic labeling data.

In some optional implementations, it is decided whether the target historical automatic labeling procedure satisfies a first quality evaluation index through the following approaches.

In certain implementations, a preset quality inspection ratio of data is randomly extracted from the automatic labeling data and the preset quality inspection ratio of data is determined as quality inspection data. In some embodiments, the quality inspection data is the data basis for deciding whether the target historical automatic labeling procedure can satisfy the labeling requirements for the automatic labeling data.

In certain embodiments, the quality inspection data are labeled using the target historical automatic labeling procedure; and a result of labeling the quality inspection data by the target historical automatic labeling procedure and a result of manual labeling the quality inspection data are obtained.

In some embodiments, it is decided whether the target historical automatic labeling procedure satisfies the first quality evaluation index in accordance with the result of labeling the quality inspection data by the target historical automatic labeling procedure and the result of manual labeling the quality inspection data.

For example, the target historical automatic labeling procedure Sₕᵢₛₜ is determined from the historical automatic labeling procedure set, and an RQA ratio (i.e., preset quality inspection ratio) of data is randomly extracted from the automatic labeling data Dₘ^{a} as the quality inspection data Dₘ^{qa}. In certain embodiments, RQA may be 5% or other ratios. The present disclosure is not limited in this regard.

In some embodiments, a labeling result Rₐ^{qa} of the target historical automatic labeling procedure is resulted from labeling the quality inspection data Dₘ^{qa} with the target historical automatic labeling procedure. In certain embodiments, the quality inspection data Dₘ^{qa} is manually labeled to obtain a labeling result Rₕ^{qa}.

In one embodiment, the quality inspection data are automatically labeled respectively by the target historical automatic labeling procedure and/or by labor. In certain embodiments, it is then decided whether the target historical automatic labeling procedure satisfies the first quality evaluation index in accordance with the automatic labeling result and the manual labeling result, wherein the first quality evaluation index includes at least one of recall rate, precision rate, accuracy rate, false positive rate and false negative rate.

In some examples,
the recall rate=true positive/(true positive+false negative);
the precision rate=true positive/(true positive+false positive);
the accuracy rate=(true positive+true negative)/whole quality inspection data;
the false positive rate=false positive/(false positive+true negative).
   where the true positive indicates the number of data items which are predicted to be positive by the target historical automatic labeling procedure and also are positive according to the manual labeling result; the false negative represents the number of data items which are predicted to be negative by the target historical automatic labeling procedure, but are positive according to the manual labeling result; the false positive denotes the number of data items which are predicted to be positive by the target historical automatic labeling procedure, but are negative according to the manual labeling result; the true negative indicates the number of data items which are predicted to be negative by the target historical automatic labeling procedure and also are negative according to the manual labeling result.

In some optional implementations, it is decided deciding whether the target historical automatic labeling procedure satisfies the first quality evaluation index in accordance with the result of labeling the quality inspection data by the target historical automatic labeling procedure and the result of manual labeling the quality inspection data.

Specifically, in some embodiments, the recall rate, the precision rate, the accuracy rate, the false positive rate and the false negative rate are calculated in accordance with the result of labeling the quality inspection data by the target historical automatic labeling procedure and the result of manual labeling the quality inspection data. It is decided whether the target historical automatic labeling procedure satisfies the first quality evaluation index in accordance with whether the recall rate, the precision rate, the accuracy rate, the false positive rate and the false negative rate are respectively greater than a recall rate threshold, a precision rate threshold, an accuracy rate threshold, a false positive rate threshold and a false negative rate threshold.

In some embodiments, in case that the recall rate, the precision rate, the accuracy rate, the false positive rate and the false negative rate are respectively greater than the recall rate threshold, the precision rate threshold, the accuracy rate threshold, the false positive rate threshold and the false negative rate threshold, it is determined that the target historical automatic labeling procedure satisfies the first quality evaluation index.

In certain embodiments, in case that at least one of the recall rate, the precision rate, the accuracy rate, the false positive rate and the false negative rate is not greater than the recall rate threshold, the precision rate threshold, the accuracy rate threshold, the false positive rate threshold and the false negative rate threshold, it is determined that the target historical automatic labeling procedure fails to satisfy the first quality evaluation index.

For example, the recall rate threshold η_{recall}, the precision rate threshold ηₚᵣ, the accuracy rate threshold η_{acc}, the false positive rate threshold η_{fhr} and the false negative rate threshold η_{fpr} may respectively are 95%, 95%, 98%, 4% and 4%. These values are only exemplary and the present disclosure is not limited in this regard.

In certain embodiments, when the recall rate, the precision rate, the accuracy rate, the false positive rate and the false negative rate resulted from labeling the quality inspection data by the target historical automatic labeling procedure are respectively greater than 95%, 95%, 98%, 4% and 4%, it is determined that the target historical automatic labeling procedure satisfies the labeling requirements for the automatic labeling data, i.e., the target historical automatic labeling procedure satisfies the first quality evaluation index.

In some embodiments, where the target historical automatic labeling procedure satisfies the first quality evaluation index, the automatic labeling data are labeled using the target historical automatic labeling procedure.

In some optional implementations, target historical automatic labeling procedure fails to satisfy the first quality evaluation index, for example when at least one of the recall rate, the precision rate, the accuracy rate, the false positive rate and the false negative rate resulted from labeling the quality inspection data by the target historical automatic labeling procedure is not greater than η_{recall}, ηₚᵣ, η_{acc}, η_{fnr} and η_{fpr}. For instance, in case the recall rate is below 95%, the target historical automatic labeling procedure fails to satisfy the first quality evaluation index.

In certain implementations, an automatic labeling procedure set is obtained based on the task type of the target labeling task. In some embodiments, the automatic labeling procedure set includes at least one automatic labeling procedure.

In some optional implementations, automatic labeling procedure set may be obtained through the following ways. Specifically, in certain embodiments, X feature extraction models and Y classifier models are respectively selected from a predefined feature extraction model base and a classifier model base in accordance with the task type of the target labeling task, X and Y being positive integers. In some embodiments, an automatic labeling procedure set is obtained from permutating and combining any one feature extraction model of the X feature extraction models with any one classifier model of the Y classifier models.

In certain embodiments, the feature extraction model is provided for extracting data features of the automatic labeling data and the classifier model is used for classifying the extracted data features.

In some embodiments, it is to be explained that when two feature extraction models or two classifier models only differ in model parameters, the two feature extraction models or the two classifier models having different parameters may be regarded as distinct feature extraction models or classifier models. Besides, different task types may correspond to various feature extraction models and classifier models. For example, images have their own corresponding feature extraction models and classifier models and texts also have their own corresponding feature extraction models and classifier models.

In certain embodiments, an automatic labeling procedure set is obtained from permutating and combining any one feature extraction model of the X feature extraction models with any one classifier model of the Y classifier models.

For example, there are feature extraction models F₁, F₂. . . F_{X} and classifier models L₁, L₂. . . L_{Y}, where X and Y are the number of the feature extraction model and the number of classifier model respectively. Any one of the feature extraction models F₁, F₂. . . F_{X} may be combined with any one of the classifier models L₁, L₂. . . L_{Y} randomly to obtain the automatic labeling procedure set S, S=S₁, S₂, S₃, . . . , S_{N′}, where N′ denotes the number of the automatic labeling procedure in the set S. Theoretically, as an example, N′ may be a product of X and Y.

After the automatic labeling procedure set is obtained, in some examples, the target automatic labeling procedure is determined based on the at least one automatic labeling procedure.

In some optional implementations, labeling quality and labeling metric of each automatic labeling procedure are calculated.

In one embodiment, to measure the labeling quality and the labeling metric, an optimal solution is sought between the labeling quality and the labeling metric by means of the Pareto under the quality control constraints and the labeling cost constraints with the optimal labeling quality and labeling metric as the object. In some examples, the first automatic labeling procedure is selected to label the automatic labeling data.

In some optional implementations, labeling quality of each automatic labeling procedure may be calculated in the following ways.

In certain implementations, the quality inspection data are randomly extracted and are labeled respectively by each automatic labeling procedure in the automatic labeling procedure set, to obtain results of labeling the quality inspection data by respective automatic labeling procedures. Besides, for example, the quality inspection data are labeled manually to obtain a result of manual labeling. In some examples, the labeling quality of at least a part of or all of the automatic labeling procedures is calculated in accordance with a result of labeling the quality inspection data by a corresponding automatic labeling strategy and the result of manual labeling the quality inspection data.

In some optional implementations, labeling quality is calculated for each automatic labeling procedure. In certain implementations, the recall rate, the precision rate, the accuracy rate and a ratio of correctly identified negatives of each of the automatic labeling procedures are calculated respectively in accordance with the result of labeling the quality inspection data by each of the automatic labeling procedures and the result of manual labeling the quality inspection data.

According to some embodiments, the labeling quality of each automatic labeling procedure is obtained through linear weighting of the recall rate, the precision rate, the accuracy rate and the ratio of correctly identified negatives.

For example, for any automatic labeling procedure Sⱼ (where j∈[1, N′]) in the automatic labeling procedure set, the quality inspection data are labeled using the automatic labeling procedure Sⱼ to obtain an automatic labeling result Rₐ^{qa}. As an example, on the basis of the automatic labeling result Rₐ^{qa} of the automatic labeling procedure Sⱼ and the manual labeling result Rₕ^{qa}, the recall rate, the precision rate, the accuracy rate and the ratio of correctly identified negatives are respectively calculated, wherein the ratio of correctly identified negatives=true negative/(true negative+false positive).

Furthermore, in certain examples, the quality evaluation index Qⱼ (where j∈[1, N′]) is calculated based on the recall rate, the precision rate, the accuracy rate and the ratio of correctly identified negatives; the quality evaluation index Qⱼ is provided for representing the labeling quality of the automatic labeling procedure Sⱼ, where,

$$\begin{matrix}Q ( . ) = ω1 \cdot Recall + ω2 \cdot \underline{Pricision} + ω3 \cdot Accuracy + ω4 \cdot \underline{{Drop}_{neg}} \\ {Q}_{j} = Q ( \underline{{S}_{j}} )\end{matrix}$$

where ω1, ω2, ω3 and ω4 respectively indicate weights corresponding to the recall rate, the precision rate, the accuracy rate and the ratio of correctly identified negatives. Recall represents the recall rate, Pricision denotes the precision rate, Accuracy indicates the accuracy rate and Drop_{neg} is the ratio of correctly identified negatives. Q (.) is a quality evaluation function, and the labeling quality of the automatic labeling procedure may be obtained on the basis of the quality evaluation function.

In some optional implementations, labeling metric of each automatic labeling procedure may be calculated in the following ways.

In certain implementations, the task characteristics of the target labeling task are obtained, the task characteristics including quantity of data items of the automatic labeling data and an average cost for manually labeling a single data item of the automatic labeling data. In some examples, the labeling metric of each automatic labeling procedure is calculated respectively in accordance with the task characteristics and the result of labeling the quality inspection data by each of the automatic labeling procedures.

For example, the labeling metric of each automatic labeling procedure may be calculated by a labeling metric function S^{cost}(.), wherein:

$$\begin{matrix}\underline{{S}^{cost}} ( \cdot ) = L \cdot P \cdot Accuracy \\ \underline{{S}_{j}^{\underline{cost}}} = \underline{{S}^{cost} ( {S}_{j} )} .\end{matrix}$$

where L refers to the quantity of data items of the automatic labeling data, P is an average cost for manually labeling a single data item of the automatic labeling data, and S^{cost}(.) indicates the labeling metric function. The labeling metric of the automatic labeling procedure is obtained on the basis of the labeling metric function.

In some optional implementations, after obtaining the labeling quality and the labeling metric, the first automatic labeling procedure is determined on this basis.

In certain embodiments, this step is provided for selecting the first automatic labeling procedure from at least a part or all automatic labeling procedures according to the labeling quality and the labeling metric after the labeling quality and the labeling metric have been obtained for each automatic labeling procedure.

In some embodiments, the automatic labeling procedure is evaluated by building a Pareto multi-objective optimization model. The Pareto multi-objective optimization model is expressed as follows:

$$\begin{matrix}\begin{matrix}\underline{max {Q}_{j}} = Q & ( \underline{{S}_{j}} )\end{matrix} \\ \underline{max} \underline{{S}_{j}^{\underline{cost}}} = \underline{{S}^{cost} ( {S}_{j} )} \\ \underline{{Q}_{l b}} ⩽ \underline{{Q}_{j}} . \\ \underline{{S}_{j}^{\underline{cost}}} ⩾ \underline{{S}_{l b}^{\underline{cost}}} . \\ j ∈ [ 1 , N ’ ] .\end{matrix}$$

where Q_{lb} is a lowest limit value of the labeling quality, and S^{cost}_{lb} indicates a lowest limit value of the labeling metric. In certain embodiments, the optimal solution to the labeling quality and the labeling metric may be found through the Pareto multi-objective optimization model.

In some optional implementations, Pareto dominance relation between any two of the automatic labeling procedure is determined based on the labeling quality and the labeling metric. The first automatic labeling procedure is determined on the basis of the Pareto dominance relation.

In some embodiments, a labeling quality set and a labeling metric set of the automatic labeling procedure are established. In other words, the labeling quality of each automatic labeling procedure constitutes the labeling quality set Q and the labeling metric of each automatic labeling procedure forms a labeling metric set S_{cost}. In certain embodiments, a labeling metric, also referred to as a labeling metric, of the automatic labeling procedure in the automatic labeling procedure set is obtained and it is decided whether the labeling metric is smaller than or equal to a labeling metric threshold.

According to some embodiments, if the labeling metric is smaller than the labeling metric threshold, the labeling quality set and the labeling metric set are traversed to calculate the Pareto dominance relation between any two of the automatic labeling procedure. In certain embodiments, a second number of rest automatic labeling procedures dominated by each of the automatic labeling procedures is calculated in accordance with the Pareto dominance relation, where the rest automatic labeling procedures indicate remaining automatic labeling procedures after selecting any one of the automatic labeling procedure from the automatic labeling procedure set. In some embodiments, the priority of the automatic labeling procedure in the automatic labeling procedure set is sorted according to the second number and the automatic labeling procedure with the highest second number is determined as the first automatic labeling procedure.

According to certain embodiments, if the labeling metric is not smaller than the labeling metric threshold, it is considered that the automatic labeling procedure has a relatively large decision variable space and it is inappropriate to find a solution by traversing. In some embodiments, the automatic labeling procedure set is taken as a decision space for a genetic algorithm, so as to obtain the first automatic labeling procedure via the genetic algorithm.

In one embodiment, the genetic algorithm may be NSGA2 (Non-dominated sorting genetic II) algorithm or NSPA algorithm. The following explanation is provided with the NSGA2 algorithm as the example:
Step 1: obtaining an initial population.

Some automatic labeling procedures are randomly selected from the automatic labeling procedure set to form an initial automatic labeling procedure, i.e., initial population.
Step 2: computing an individual fitness.

The individual fitness is calculated for each automatic labeling procedure in the initial population, where the individual fitness refers to the labeling quality and the labeling metric of the automatic labeling procedure.
Step 3: computing a crowding distance value.

The crowding distance value is calculated for each automatic labeling procedure in a different automatic labeling procedure. The crowding distance indicates surrounding density of the automatic labeling procedure and the solution diversity is measured by computing the crowding distance value of the automatic labeling procedure. The automatic labeling procedure may be maintained to be heterogeneous in the iteration. For example, both the automatic labeling procedures A and B dominate 5 solutions. To maintain diversity in the next iteration, the automatic labeling procedure with a greater crowding distance value is selected for iteration. As the crowding distance value grows smaller, it indicates that the automatic labeling procedure has become more homogeneous.
Step 4: performing non-dominated sorting on the automatic labeling procedure.

The non-dominance between any two automatic labeling procedures is obtained in accordance with the labeling quality and the labeling metric of the automatic labeling procedure, so as to perform non-dominated sorting on the automatic labeling procedure. The non-dominated sorting refers to dividing the automatic labeling procedure into a plurality of layers, and no dominance is present between the automatic labeling procedure within each layer, i.e., no automatic labeling procedure is superior to another automatic labeling procedure over all target functions (i.e., labeling quality and labeling metric).
Step 5: selecting operation.

Subsequent to the non-dominated sorting on the automatic labeling procedure, a given number of automatic labeling procedures may be selected from the automatic labeling procedure and added into a next generation of population, i.e., next generation of the automatic labeling procedure. For example, to maintain diversity of the next generation of population, the automatic labeling procedure may be selected in tournament fashion.
Step 6: crossover operation.

Subsequent to the crossover operation on the automatic labeling procedure, a mutation operation is further performed on the post-crossover automatic labeling procedure to further add diversity to the automatic labeling procedure. The mutation operation on the automatic labeling procedure refers to vary the binary code of the automatic labeling procedure.

Through the above process, for example, the initial population is subject to selection, crossover, mutation and variation operations to generate a next generation of population, i.e., the next generation of automatic labeling procedure. In some examples, the next generation of population includes part of the automatic labeling procedures in the previous generation of population and part of the newly generated automatic labeling procedures. In certain examples, the steps 2-7 are repeated until a preset number of iterations is met or a termination condition is satisfied. In some embodiments, the genetic algorithm outputs the first automatic labeling procedure.

In certain embodiments, the Pareto dominance relation between any two automatic labeling procedures is calculated and the highest automatic labeling procedure is determined as the first automatic labeling procedure.

In some optional implementations, it is decided whether the first automatic labeling procedure satisfies the first quality evaluation index.

In one embodiment, the quality inspection data is automatically labeled by the first automatic labeling procedure and manually labeled by labor. In certain embodiments, it is decided whether the first automatic labeling procedure satisfies the first quality evaluation index in accordance with the labeling result of the first automatic labeling procedure and the manual labeling result. Specifically, in some embodiments, the quality inspection data are labeled with the first automatic labeling procedure. In certain embodiments, it is decided whether the first automatic labeling procedure is greater than a quality control threshold of the first quality evaluation index in accordance with a result of labeling the quality inspection data by the first automatic labeling procedure and the result of manual labeling the quality inspection data. If greater, in some examples, it is determined that the first automatic labeling procedure satisfies the first quality evaluation index and the first automatic labeling procedure is decided as the target automatic labeling procedure. If not greater, in certain examples, it is determined that the first automatic labeling procedure fails to satisfy the first quality evaluation index.

According to certain embodiments, it is determined that the first automatic labeling procedure fails to satisfy the first quality evaluation index, the automatic labeling data are divided into unlabeled data and labeled data. In some embodiments, the unlabeled data is equal to the automatic labeling data and the labeled data is empty.

In certain embodiments, the automatic labeling data of the target labeling task is determined as unlabeled data. In some embodiments, to update the first automatic labeling procedure until a Pareto target value of the first automatic labeling procedure converges, the unlabeled data are performed with following extraction and labeling operations.

To be specific, in some embodiments, a random extraction is performed on the unlabeled data to obtain randomly extracted data. In certain embodiments, a contribution value of respective data items in the randomly extracted data to a multi-objective optimization model is calculated, the multi-objective optimization model being provided for computing a Pareto optimal target value of the first automatic labeling procedure. In some embodiments, data items are selected from the randomly extracted data in accordance with contribution values of the respective data items in the randomly extracted data, to form extraction data with high contribution value. In certain embodiments, the extraction data are manually labeled with high contribution value to obtain a corresponding manual labeling result. In some embodiments, the Pareto optimal target value of the first automatic labeling procedure is re-calculated in accordance with the extraction data with high contribution value and a corresponding manual labeling result; the first automatic labeling procedure is updated based on the extraction data with high contribution value and the corresponding manual labeling result; and the unlabeled data are updated according to the extraction data with high contribution value and the corresponding manual labeling result; and the execution of the extraction and labeling operations resumes based on the unlabeled data updated until the Pareto target value converges.

According to certain embodiments, it is to be explained that the multi-objective optimization model here may be the Pareto multi-objective optimization model. In an optional embodiment, the contribution values of respective data items may be the contribution values of the extracted data to the multi-objective optimization model determined according to density weights or variances of the extracted data.

In some embodiments, the data items are selected from the randomly extracted data to form extraction data with high contribution value, wherein the extraction data with high contribution value may be data items with contribution value greater than a preset contribution value threshold.

For example, as the variance of the extraction data grows larger, it means that the extraction data make an increasingly large contribution to the multi-objective optimization model. As an example, the data items having a variance greater than a preset contribution value threshold are determined as extraction data with high contribution value.

In certain examples, the Pareto optimal target value of the first automatic labeling procedure is re-calculated in accordance with the extraction data with high contribution value and a corresponding manual labeling result; and the first automatic labeling procedure is updated based on the extraction data with high contribution value and the corresponding manual labeling result.

In one embodiment, the calculation of the Pareto optimal target value refers to computing the labeling quality and the labeling metric. Subsequent to the manual labeling of the extraction data with high contribution value, in some examples, the extraction data with high contribution value are stored as the labeled data and the unlabeled data are also updated. In certain examples, the updated unlabeled data no longer includes the extraction data with high contribution value which have been manually labeled. Then, in some embodiments, the execution of the extraction and labeling operations resumes based on the unlabeled data updated until the Pareto target value converges.

If the Pareto target value converges, in certain examples, it means that the variation between the Pareto optimal target values in two adjacent iterations is smaller than convergence thresholds Δ₁ and Δ₂, where Δ₁ indicates a convergence threshold of the labeling quality and Δ₂ denotes a convergence threshold of the labeling metric. In some examples, the convergence thresholds Δ₁ and Δ₂ are data between 0 and 1. Additionally or alternatively, they also may be data outside the range from 0 to 1. In certain examples, the convergence thresholds Δ₁ and Δ₂ may be dynamically adjusted. Besides, in some examples, a small convergence threshold indicates that a more accurate labeling of the multi-objective optimization model, i.e., the first automatic labeling procedure.

Furthermore, in some embodiments, the optimized first automatic labeling procedure may be stored into the database. In certain embodiments, when a labeling task matches with the first automatic labeling procedure, the automatic labeling data of the labeling task are labeled using the first automatic labeling procedure.

At step 205, in some embodiments, the automatic labeling data are labeled using the target automatic labeling procedure.

In certain embodiments, if it is decided whether the first automatic labeling procedure satisfies the first quality evaluation index, the first automatic labeling procedure is determined as the target automatic labeling procedure. In some embodiments, the automatic labeling data are labeled using the automatic labeling procedure.

In the data labeling method provided by the embodiments of the present disclosure, according to some embodiments, a data labeling request is received. In certain embodiments, the labeling priority of a labeling task is determined by a labeling index and an index value in the data labeling request. In some embodiments, the labeling data are then divided into automatic labeling data and manual labeling data by constraints. In certain embodiments, for the automatic labeling data, it is first determined whether the automatic labeling data are labeled with a historical labeling strategy based on the labeling quality of the historical automatic labeling procedure. If not, in some embodiments, the automatic labeling procedure is obtained and the first automatic labeling procedure is determined according to the labeling quality and the labeling metric of the automatic labeling procedure. In certain embodiments, the labeling quality of the first automatic labeling procedure is then decided, so as to determine whether the automatic labeling data are labeled by the first automatic labeling procedure. In some embodiments of the present disclosure, multiple target values, including data labeling quality, labeling efficiency and labor costs etc., are dynamically balanced, to achieve better resource allocation and provide an individualized labeling configuration for each labeling task.

Although the above has been shown using a selected group of steps for the flowchart 200, there can be many alternatives, modifications, and variations. For example, some of the steps may be expanded and/or combined. Other steps may be inserted into those noted above. Depending upon the embodiment, the sequence of steps may be interchanged with others replaced. Further details of these steps are found throughout the present disclosure.

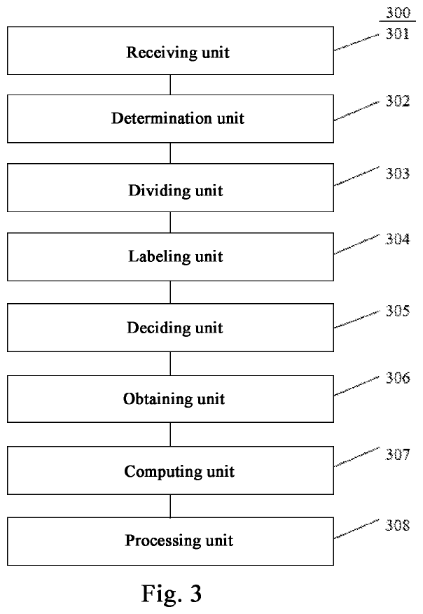

With reference to FIG. 3, as an implementation for the method illustrated by the respective drawings, the present disclosure provides an embodiment of a data labeling apparatus (e.g., a data labeling system). The apparatus embodiment corresponds to the method embodiment shown in FIG. 2. Specifically, the apparatus may be applied into a variety of computing devices.

FIG. 3 illustrates the data labeling apparatus (e.g., a data labeling system) 300 according to certain embodiments. The apparatus 300 comprises: a receiving unit 301, a determination unit 302, a dividing unit 303, a labeling unit 304, a deciding unit 305, an obtaining unit 306, a computing unit 307 and a processing unit 308.

In one embodiment, specific processing of the receiving unit 301, the determination unit 302, the dividing unit 303, the labeling unit 304, the deciding unit 305, the obtaining unit 306, the computing unit 307 and the processing unit 308 in the data labeling apparatus and the resulting technical effects may refer to the explanations related to steps 201 to 205 in the corresponding embodiment of FIG. 2 and will not be repeated here.

In some embodiments, the receiving unit 301 is provided for receiving a data labeling request, the data labeling request including at least one labeling task and a task type, labeling data, a constraint and a labeling index value corresponding to each labeling task; the labeling data including at least one data item and the constraints including at least one constraint condition.

In certain embodiments, the determination unit 302 is used for determining a target labeling task based on the labeling index value of each labeling task.

In some embodiments, the dividing unit 303 is provided for dividing, based on the constraints, the labeling data of the target labeling task into automatic labeling data and manual labeling data.

In certain embodiments, the determination unit 302 is also used for determining a target automatic labeling procedure in accordance with at least one of task type, labeling quality and labeling metric of a task to be labeled.

In some embodiments, the labeling unit 304 is provided for labeling the automatic labeling data using the target automatic labeling procedure.

In some optional implementations, the determination unit 302 is also used for determining a target automatic labeling procedure in accordance with at least one of task type, labeling quality and labeling metric of a task to be labeled.

In certain embodiments, the determination unit 302 is also provided for determining, based on the task type of the target labeling task, whether a historical automatic labeling procedure corresponding to the target labeling task is present; if present, the deciding unit 305 determines the historical automatic labeling procedure as a target historical automatic labeling procedure and decides whether the target historical automatic labeling procedure satisfies a first quality evaluation index; if not satisfied, the obtaining unit 306 obtains an automatic labeling procedure set based on the task type of the target labeling task, the automatic labeling procedure set including at least one automatic labeling procedure.

In some embodiments, the determination unit 302 also determines, based on the at least one automatic labeling procedure, a target automatic labeling procedure.

In some optional implementations, the determination unit 302 also determines, based on the at least one automatic labeling procedure, a target automatic labeling procedure.

In certain embodiments, the computing unit 307 is provided for computing labeling quality and labeling metric of each automatic labeling procedure.

In some embodiments, the determination unit 302 also determines a first automatic labeling procedure based on the labeling quality and the labeling metric.

In certain embodiments, the deciding unit 305 further decides whether the first automatic labeling procedure satisfies the first quality evaluation index; if satisfied, the determination unit 302 determines the first automatic labeling procedure as the target automatic labeling procedure.

In some optional implementations, the determination unit 302 is also used for determining a target labeling task based on the labeling index value of each labeling task.

In certain embodiments, the computing unit 307 calculates a first number of rest labeling tasks dominated by each labeling task in accordance with the labeling index value of each labeling task, where the rest labeling tasks indicate remaining labeling tasks after selecting any one labeling task from the at least one labeling task. In some embodiments, the determination unit 302 also sorts the priority of the at least one labeling task according to the first number and determines a labeling task with the highest first number as the target labeling task.

In some optional implementations, the dividing unit 303 is also provided for dividing, based on the constraints, the labeling data of the target labeling task into automatic labeling data and manual labeling data. In some embodiments, the deciding unit 305 also decides whether each data item in the labeling data satisfies each constraint condition of the constraints corresponding to the target labeling task respectively; if satisfied, the determination unit 302 determines data items of the labeling data as automatic labeling data; if not satisfied, the determination unit 302 also determines data items of the labeling data as manual labeling data.

In some optional implementations, the determination unit 302 is also used for determining data items of the labeling data as manual labeling data.

In certain embodiments, the determination unit 302 also determines a target pre-filter procedure according to the task type of the target labeling task. In some embodiments, the deciding unit 305 further decides respectively whether each data item in the manual labeling data satisfies a target pre-filter procedure threshold in accordance with the target pre-filter procedure; if satisfied, the processing unit 308 sends the data items to a manual labeling data item queue; if not satisfied, the determination unit 302 also determines the data items as negatives and discard them.

In some optional implementations, the determination unit 203 is also used for determining a target pre-filter procedure according to the task type of the target labeling task.

In some embodiments, the obtaining unit 306 also obtains a pre-filter procedure set including at least one pre-filter procedure, wherein each pre-filter procedure corresponds to a task type of a filterable labeling task, and the pre-filter procedure is provided for discarding negatives in the manual labeling data.

In some embodiments, the processing unit 308 further matches the task type of the target labeling task with the task type of the filterable labeling task corresponding to the pre-filter procedure; and the determination unit 302 determines whether the task type of the filterable labeling task corresponding to the pre-filter procedure includes the task type of the target labeling task; if yes, the determination unit 302 also determines the pre-filter procedure corresponding to the task type of the target labeling task as the target pre-filter procedure.

In some optional implementations, the determination unit 302 is also used for determining, based on the task type of the target labeling task, whether a historical automatic labeling procedure corresponding to the target labeling task is present.

In some embodiments, the obtaining unit 306 is used for obtaining a historical automatic labeling procedure set, the historical automatic labeling procedure set including at least one historical automatic labeling procedure, wherein each of the historical automatic labeling procedure corresponds to a task type of a labelable task, and the historical automatic labeling procedure is provided for labeling the automatic labeling data.

In some embodiments, the processing unit 308 is provided for matching the task type of the target labeling task with the task type of the labelable task corresponding to the historical automatic labeling procedure.

In some embodiments, the determination unit 302 is also used for determining whether the historical automatic labeling procedure corresponding to the target labeling task is present in accordance with whether the task type of the labelable task corresponding to the historical automatic labeling procedure includes the task type of the target labeling task.

In some optional implementations, the determination unit 302 is also used for determining whether the historical automatic labeling procedure corresponding to the target labeling task is present in accordance with whether the task type of the labelable task corresponding to the historical automatic labeling procedure includes the task type of the target labeling task.

If not present, in some examples, the determination unit 302 determines the automatic labeling data as the manual labeling data.

In some optional implementations, the deciding unit 305 is also used for deciding whether the target historical automatic labeling procedure satisfies a first quality evaluation index.

In some embodiments, the processing unit 308 is also provided for randomly extracting a preset quality inspection ratio of data from the automatic labeling data and determining the preset quality inspection ratio of data as quality inspection data.

In some embodiments, the labeling unit is also used for labeling the quality inspection data using the target historical automatic labeling procedure.

In some embodiments, the obtaining unit 306 is also used for obtaining a result of labeling the quality inspection data by the target historical automatic labeling procedure and a result of manual labeling the quality inspection data.

In certain embodiments, the deciding unit 305 is also provided for deciding whether the target historical automatic labeling procedure satisfies the first quality evaluation index in accordance with the result of labeling the quality inspection data by the target historical automatic labeling procedure and the result of manual labeling the quality inspection data.

In some optional implementations, the first quality evaluation index includes recall rate, precision rate, accuracy rate, false positive rate and false negative rate; and

In some embodiments, the deciding unit 305 is also used for deciding whether the target historical automatic labeling procedure satisfies the first quality evaluation index in accordance with the result of labeling the quality inspection data by the target historical automatic labeling procedure and the result of manual labeling the quality inspection data.

In certain embodiments, the computing unit 307 is also used for computing the recall rate, the precision rate, the accuracy rate, the false positive rate and the false negative rate in accordance with the result of labeling the quality inspection data by the target historical automatic labeling procedure and the result of manual labeling the quality inspection data.

In some embodiments, the deciding unit 305 is also used for deciding whether the target historical automatic labeling procedure satisfies the first quality evaluation index in accordance with whether the recall rate, the precision rate, the accuracy rate, the false positive rate and the false negative rate are respectively greater than a recall rate threshold, a precision rate threshold, an accuracy rate threshold, a false positive rate threshold and a false negative rate threshold.

In some embodiments, the determination unit 302 is also provided for determining that the target historical automatic labeling procedure satisfies the first quality evaluation index in case that the recall rate, the precision rate, the accuracy rate, the false positive rate and the false negative rate are respectively greater than the recall rate threshold, the precision rate threshold, the accuracy rate threshold, the false positive rate threshold and the false negative rate threshold.

In certain embodiments, the determination unit 302 is also used for determining that the target historical automatic labeling procedure fails to satisfy the first quality evaluation index in case that at least one of the recall rate, the precision rate, the accuracy rate, the false positive rate and the false negative rate is not greater than the recall rate threshold, the precision rate threshold, the accuracy rate threshold, the false positive rate threshold and the false negative rate threshold.

In some optional implementations, the deciding unit 305 is also used for deciding whether the target historical automatic labeling procedure satisfies the first quality evaluation index.

If satisfied, in certain embodiments, the labeling unit 304 is also used for labeling the automatic labeling data with the target historical automatic labeling procedure.

In some optional implementations, the obtaining unit 306 is also used for obtaining an automatic labeling procedure set based on the task type of the target labeling task.

In some embodiments, the processing unit 308 is also provided for selecting from a predefined feature extraction model base and a classifier model base X feature extraction models and Y classifier models respectively in accordance with the task type of the target labeling task, X and Y being positive integers.

The processing unit 308 is also used for obtaining an automatic labeling procedure set from permutating and combining any one feature extraction model of the X feature extraction models with any one classifier model of the Y classifier models.

In some optional implementations, the calculation unit is also used for computing labeling quality and labeling metric of each automatic labeling procedure.

In some embodiments, the labeling unit 304 is provided for labeling the quality inspection data respectively with each of the automatic labeling procedures.

In certain embodiments, the computing unit 307 is also provided for computing labeling quality of each of the automatic labeling procedures in accordance with a result of labeling the quality inspection data by each of the automatic labeling procedures and the result of manual labeling the quality inspection data.

In some embodiments, the obtaining unit 307 is also used for obtaining task characteristics of the target labeling task, the task characteristics including quantity of data items of the automatic labeling data and an average cost for manually labeling a single data item of the automatic labeling data.

In certain embodiments, the computing unit 307 is also provided for computing labeling metric of each of the automatic labeling procedures respectively in accordance with the task characteristics and the result of labeling the quality inspection data by each of the automatic labeling procedures.

In some optional implementations, the computing unit 307 is also used for computing labeling quality of each of the automatic labeling procedures in accordance with a result of labeling the quality inspection data by each of the automatic labeling procedures and the result of manual labeling the quality inspection data.

In some embodiments, the computing unit 307 is also provided for computing the recall rate, the precision rate, the accuracy rate and a ratio of correctly identified negatives of each of the automatic labeling procedures respectively in accordance with the result of labeling the quality inspection data by each of the automatic labeling procedures and the result of manual labeling the quality inspection data.

In certain embodiments, the processing unit 308 is also used for obtaining labeling quality of each of the automatic labeling procedures through linear weighting of the recall rate, the precision rate, the accuracy rate and the ratio of correctly identified negatives.

In some optional implementations, the determination unit 302 is also used for determining a first automatic labeling procedure based on the labeling quality and the labeling metric.

In some embodiments, the processing unit 308 is used for computing Pareto dominance relation between any two of the automatic labeling procedure based on the labeling quality and the labeling metric.

In certain embodiments, the determination unit 302 is also provided for determining the first automatic labeling procedure on the basis of the Pareto dominance relation.

In some optional implementations, the computing unit 307 is also used for computing Pareto dominance relation between any two of the automatic labeling procedure based on the labeling quality and the labeling metric.

In some embodiments, the processing unit 308 is also used for establishing a labeling quality set and a labeling metric set of the automatic labeling procedure.

In certain embodiments, the obtaining unit 306 is also used for obtaining a labeling metric of the automatic labeling procedure in the automatic labeling procedure set.

In some embodiments, the deciding unit 305 is provided for deciding whether the labeling metric is smaller than or equal to a labeling metric threshold.

In certain embodiments, if the labeling metric is smaller than the labeling metric threshold, the processing unit 308 is also used for traversing the labeling quality set and the labeling metric set and the computing unit 307 is provided for computing Pareto dominance relation between any two of the automatic labeling procedure.

In some optional implementations, the determination unit 302 is also used for determining the first automatic labeling procedure on the basis of the Pareto dominance relation.

In some embodiments, the computing unit 307 is used for computing a second number of rest automatic labeling procedures dominated by each of the automatic labeling procedures in accordance with the Pareto dominance relation, where the rest automatic labeling procedures indicate remaining automatic labeling procedures after selecting any one of the automatic labeling procedure from the automatic labeling procedure set.

In certain embodiments, the processing unit 308 is also provided for sorting priority of the automatic labeling procedure in the automatic labeling procedure set according to the second number and determining the automatic labeling procedure with the highest second number as the first automatic labeling procedure.

In some embodiments, if the labeling metric is not smaller than the labeling metric threshold, the processing unit 308 is also provided for taking the automatic labeling procedure set as a decision space for a genetic algorithm, so as to obtain the first automatic labeling procedure via the genetic algorithm.

In some optional implementations, the deciding unit 305 is also used for deciding whether the first automatic labeling procedure satisfies the first quality evaluation index.

In some embodiments, the processing unit 308 is also used for labeling the quality inspection data with the first automatic labeling procedure.

In some embodiments, the deciding unit 305 is also provided for deciding whether the first automatic labeling procedure is greater than a quality control threshold of the first quality evaluation index in accordance with a result of labeling the quality inspection data by the first automatic labeling procedure and the result of manual labeling the quality inspection data; if greater, the determination unit 203 also determines that the first automatic labeling procedure satisfies the first quality evaluation index; if not greater, the determination unit 203 also determines that the first automatic labeling procedure fails to satisfy the first quality evaluation index.

In some optional implementations, the determination unit 302 is also used for determining that the first automatic labeling procedure fails to satisfy the first quality evaluation index.

In some embodiments, the determination unit 302 is also used for determining the automatic labeling data of the target labeling task as unlabeled data.

In certain embodiments, to update the first automatic labeling procedure until a Pareto target value of the first automatic labeling procedure converges, the processing unit 308 also performs following extraction and labeling operations on the unlabeled data.

In some embodiments, the processing unit 308 is used for performing random extraction on the unlabeled data to obtain randomly extracted data.

In certain embodiments, the computing unit 307 is also used for computing a contribution value of respective data items in the randomly extracted data to a multi-objective optimization model, the multi-objective optimization model being provided for computing a Pareto optimal target value of the first automatic labeling procedure.

In some embodiments, the processing unit 308 is also provided for selecting data items from the randomly extracted data in accordance with contribution values of the respective data items in the randomly extracted data, to form extraction data with high contribution value.

In certain embodiments, the labeling unit 304 is also used for manually labeling the extraction data with high contribution value to obtain a corresponding manual labeling result.

In some embodiments, the computing unit 307 is also used for re-computing a Pareto optimal target value of the first automatic labeling procedure in accordance with the extraction data with high contribution value and a corresponding manual labeling result; the processing unit 308 is also used for 8 updating the first automatic labeling procedure based on the extraction data with high contribution value and the corresponding manual labeling result; and updating the unlabeled data according to the extraction data with high contribution value and the corresponding manual labeling result; and continuing to execute the extraction and labeling operations based on the unlabeled data updated until the Pareto target value converges.

It is to be explained that implementation details and technical effects of respective units in the data labeling apparatus provided by the embodiments of the present disclosure may refer to explanations of other embodiments in the present disclosure and will not be repeated here.

In certain embodiments, various components in the data labeling apparatus (e.g., a data labeling system) 300 can retrieve, accress, read, write, modify, and/or delete data from a data repository. A data repository may include random access memories, flat files, XML files, and/or one or more database management systems (DBMS) executing on one or more database servers or a data center. A database management system may be a relational (RDBMS), hierarchical (HDBMS), multidimensional (MDBMS), object oriented (ODBMS or OODBMS) or object relational (ORDBMS) database management system, and the like. The data repository may be, for example, a single relational database. In some cases, the data repository may include a plurality of databases that can exchange and aggregate data by data integration process or software application. In an exemplary embodiment, at least part of the data repository may be hosted in a cloud data center. In some cases, a data repository may be hosted on a single computer, a server, a storage device, a cloud server, or the like. In some other cases, a data repository may be hosted on a series of networked computers, servers, or devices. In some cases, a data repository may be hosted on tiers of data storage devices including local, regional, and central.

In some embodiments, various components in the data labeling apparatus (e.g., a data labeling system) 300 can execute software or firmware stored in non-transitory computer-readable medium to implement various processing steps. Various components and processors of the data labeling apparatus (e.g., a data labeling system) 300 can be implemented by one or more computing devices including, but not limited to, circuits, a computer, a cloud-based processing unit, a processor, a processing unit, a microprocessor, a mobile computing device, and/or a tablet computer. In some embodiments, various components of the data labeling apparatus (e.g., a data labeling system) 300 can be implemented on a shared computing device. In certain embodiments, a component of the data labeling apparatus (e.g., a data labeling system) 300 can be implemented on multiple computing devices. In certain embodiments, a component of the data labeling apparatus (e.g., a data labeling system) 300 can be implemented on multiple computing devices working in parallel. In some implementations, various modules and components of the data labeling apparatus (e.g., a data labeling system) 300 can be implemented as software, hardware, firmware, or a combination thereof. In some cases, various components of the data labeling apparatus (e.g., a data labeling system) 300 can be implemented in software or firmware executed by a computing device.

Various components of the data labeling apparatus (e.g., a data labeling system) 300 can communicate via or be coupled to via a communication interface, for example, a wired or wireless interface. The communication interface includes, but is not limited to, any wired or wireless short-range and long-range communication interfaces. The short-range communication interfaces may be, for example, local area network (LAN), interfaces conforming known communications standard, such as Bluetooth® standard, IEEE 802 standards (e.g., IEEE 802.11), or similar standards, such as those based on the IEEE 802.15.4 standard, or other public or proprietary wireless protocol. The long-range communication interfaces may be, for example, wide area network (WAN), cellular network interfaces, satellite communication interfaces, etc. The communication interface may be either within a private computer network, such as intranet, or on a public computer network, such as the internet.

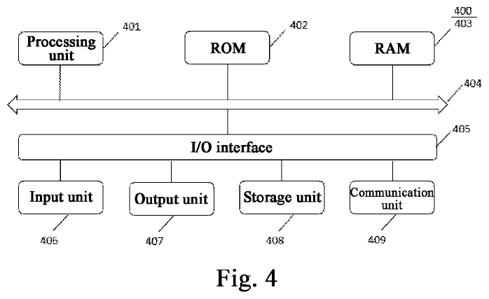

FIG. 4 below illustrates a structural diagram of a computer system 400 suitable for implementing the computing device of the present disclosure. The computer system 400 shown in FIG. 4 is just an example and will not put any restrictions on the functions and application ranges of the embodiments of the present disclosure.

According to FIG. 4, the computer system 400 may include a processing unit (e.g., a central processing unit, a graphic processing unit, a tensor processing unit, and/or the like) 401, which can execute various suitable actions and processing based on the programs stored in the read-only memory (ROM) 402 or programs loaded in the random-access memory (RAM) 403 from a storage unit 608. The RAM 403 can also store various programs and data required by the operations of the computer system 400. Processing unit 401, ROM 402 and RAM 403 are connected to each other via a bus 404. The input/output (I/O) interface 405 is also connected to the bus 404.

Usually, in some embodiments, input unit 406 (including touch screen, touchpad, keyboard, mouse, camera, microphone, accelerometer, gyroscope and like) and output unit 407 (including liquid crystal display (LCD), speaker and vibrator etc.), storage unit 408 (including tape and hard disk etc.) and communication unit 409 may be connected to the I/O interface 405. The communication unit 409 may allow the computer system 400 to exchange data with other devices through wired or wireless communications. Although FIG. 4 illustrates the computer system 400 having various units, it is to be understood that it is not a prerequisite to implement or provide all illustrated units. Alternatively, more or less units may be implemented or provided.

In particular, in accordance with embodiments of the present disclosure, the process depicted above with reference to the flowchart may be implemented as computer software programs. For example, the embodiments of the present disclosure include a computer program product including computer programs carried on a non-transitory computer readable medium, wherein the computer programs include program codes for executing a method demonstrated by a flowchart. In these embodiments, the computer programs may be loaded and installed from networks via the communication unit 409, or installed from the storage unit 408, or installed from the ROM 402. The computer programs, when executed by the processing unit 401, performs the above functions defined in the method according to the embodiments of the present disclosure.

It is to be explained the above disclosed computer readable medium may be computer readable signal medium or computer readable storage medium or any combinations thereof. The computer readable storage medium for example may include, but not limited to, electric, magnetic, optical, electromagnetic, infrared or semiconductor systems, apparatus or devices or any combinations thereof. Specific examples of the computer readable storage medium may include, but not limited to, electrical connection having one or more wires, portable computer disk, hard disk, random access memory (RAM), read-only memory (ROM), erasable programmable read only memory (EPROM or flash memory), fiber optics, portable compact disk read only memory (CD-ROM), optical storage device, magnetic storage device, or any suitable combinations thereof. In the present disclosure, the computer readable storage medium may be any tangible medium that contains or stores programs. The programs may be utilized by instruction execution systems, apparatuses or devices in combination with the same.

In the present disclosure, the computer readable signal medium may include a data signal propagated in baseband or as part of a carrier wave, carrying computer readable program codes therein. Such propagated data signals may take many forms, including but not limited to, electromagnetic signals, optical signals, or any suitable combinations thereof. The computer readable signal medium may also be any computer readable medium in addition to the computer readable storage medium. The computer readable signal medium may send, propagate, or transmit programs for use by or in connection with instruction execution systems, apparatuses or devices. Program codes contained on the computer readable medium may be transmitted by any suitable media, including but not limited to: electric wires, fiber optic cables and RF (radio frequency) etc., or any suitable combinations thereof.

The computer readable medium may be included in the aforementioned electronic device or stand-alone without fitting into the electronic device.

The computer readable medium bears one or more programs. When the one or more programs are executed by the electronic device, the electronic device is enabled to implement the data labeling method as illustrated by the embodiments of FIG. 2 and other alternative implementations.

The computer program instructions for executing operations of the present disclosure may be written in one or more programming languages or combinations thereof. The programming languages include object-oriented programming languages, e.g., Java, Smalltalk, C++ and so on, and traditional procedural programming languages, such as “C” language or similar programming languages. The program codes can be implemented fully on the user computer, partially on the user computer, as an independent software package, partially on the user computer and partially on the remote computer, or completely on the remote computer or server. In the case where remote computer is involved, the remote computer can be connected to the user computer via any type of networks, including local area network (LAN) and wide area network (WAN), or to the external computer (e.g., connected via Internet using the Internet service provider).

The flow chart and block diagram in the drawings illustrate system architecture, functions and operations that may be implemented by system, method and computer program product according to various implementations of the present disclosure. In this regard, each block in the flow chart or block diagram can represent a module, a part of program segment or code, wherein the module and the part of program segment or code include one or more executable instructions for performing stipulated logic functions. In some optional implementations, it should be noted that the functions indicated in the block can also take place in an order different from the one indicated in the drawings. For example, two successive blocks can be in fact executed in parallel or sometimes in a reverse order dependent on the involved functions. It should also be noted that each block in the block diagram and/or flow chart and combinations of the blocks in the block diagram and/or flow chart can be implemented by a hardware-based system exclusive for executing stipulated functions or actions, or by a combination of dedicated hardware and computer instructions.

Units described in the embodiments of the present disclosure may be implemented by software or hardware. In some cases, the name of the unit should not be considered as the restriction over the unit per se. For example, the receiving unit may also be depicted as “unit for receiving data labeling requests”.

According to some embodiments, a method for data labeling, the method comprising: receiving a data labeling request, the data labeling request including one or more labeling tasks, one or more task types corresponding to the one or more labeling tasks, labeling data, a constraint, one or more labeling index values corresponding to the one or more labeling asks, the labeling data including one or more data items, the constraint including one or more constraint conditions; determining a target labeling task based on the one or more labeling index values and the one or more labeling tasks; dividing, based on the constraint, the labeling data of the target labeling task into automatic labeling data and manual labeling data; determining a labeling procedure based on the data labeling request and at least one selected from a group consisting of the task type, a labeling quality, and a labeling metric; and labeling the automatic labeling data using the labeling procedure.

According to certain embodiments, an electronic device comprises: one or more memories comprising instructions stored thereon; and one or more processors configured to execute the instructions and perform operations comprising: receiving a data labeling request, the data labeling request including one or more labeling tasks, one or more task types corresponding to the one or more labeling tasks, labeling data, a constraint, one or more labeling index values corresponding to the one or more labeling asks, the labeling data including one or more data items, the constraint including one or more constraint conditions; determining a target labeling task based on the one or more labeling index values and the one or more labeling tasks; dividing, based on the constraint, the labeling data of the target labeling task into automatic labeling data and manual labeling data; determining a labeling procedure based on at least one selected from a group consisting of the task type, a labeling quality, and a labeling metric; and labeling the automatic labeling data using the labeling procedure.

According to some embodiments, a non-transitory computer readable storage medium stored instructions thereon, the instructions, when executed by one or more processors, cause the one or more processors to perform operations comprising: receiving a data labeling request, the data labeling request including one or more labeling tasks, one or more task types corresponding to the one or more labeling tasks, labeling data, a constraint, one or more labeling index values corresponding to the one or more labeling asks, the labeling data including one or more data items, the constraint including one or more constraint conditions; determining a target labeling task based on the one or more labeling index values and the one or more labeling tasks; dividing, based on the constraint, the labeling data of the target labeling task into automatic labeling data and manual labeling data; determining a labeling procedure based on at least one selected from a group consisting of the task type, a labeling quality, and a labeling metric; and labeling the automatic labeling data using the labeling procedure.

In certain embodiments, determining the labeling procedure based on the data labeling request and at least one selected from a group consisting of the task type, the labeling quality, and the labeling metric comprises: determining, based on a task type of the target labeling task, whether an existing labeling procedure corresponding to the target labeling task is present; if the existing labeling procedure is present, determining whether the existing labeling procedure satisfies a first quality evaluation index; and if the existing labeling procedure is not present: obtaining a set of automatic labeling procedures based on the task type of the target labeling task; and determining, based on the set of automatic labeling procedures, the labeling procedure. In some embodiments, determining, based on the set of automatic labeling procedures, the labeling procedure comprises: computing a labeling quality and a labeling metric of each automatic labeling procedure in the set of automatic labeling procedures; determining a first automatic labeling procedure based on the labeling quality and the labeling metric; determining whether the first automatic labeling procedure satisfies the first quality evaluation index; if the first automatic labeling procedure satisfies the first quality evaluation index, setting the first automatic labeling procedure as the labeling procedure.

In certain embodiments, determining the target labeling task based on the one or more labeling index values and the one or more labeling tasks comprises: computing one or more first numbers corresponding to one or more labeling tasks by at least: for each labeling task in the one or more labeling tasks, computing a first number of a rest of the labeling tasks dominated by the each labeling task based on a corresponding labeling index value of the each labeling task, wherein the rest of the labeling tasks are one or more remaining labeling tasks after selecting a labeling task from the one or more labeling tasks; sorting a priority of one or more labeling tasks based on the one or more first numbers; and determining a labeling task with the highest first number in the one or more first numbers as the target labeling task. In some embodiments, dividing, based on the constraint, the labeling data of the target labeling task into automatic labeling data and manual labeling data comprises: deciding whether each data item of the one or more data items in the labeling data satisfies each constraint condition of the one or more constraint conditions of the constraint; assigning one or more data items of the labeling data satisfying the constraint as the automatic labeling data; assigning one or more data items of the labeling data not satisfying the constraint as the manual labeling data.

In certain embodiments, assigning one or more data items of the labeling data not satisfying the constraint as the manual labeling data comprises: determining a target pre-filter procedure based on a task type of the target labeling task; determining, respectively, whether each data item of the one or more data items in the manual labeling data satisfies a target pre-filter procedure threshold based on the target pre-filter procedure; sending one or more data items satisfying the target pre-filter procedure threshold to a manual labeling data item queue; discarding one or more data items not satisfying the target pre-filter procedure threshold. In some embodiments, determining the target pre-filter procedure according to the task type of the target labeling task comprises: obtaining a set of pre-filter procedures, wherein each pre-filter procedure in the set of pre-filter procedures corresponds to a task type, and each pre-filter procedure includes discarding negatives in the manual labeling data; matching the task type of the target labeling task with one or more task types corresponding to the set of pre-filter procedures to identifying a matched pre-filter procedure in the set of pre-filter procedures; assigning the matched pre-filter procedure as the target pre-filter procedure.

In certain embodiments, determining, based on the task type of the target labeling task, whether the existing automatic labeling procedure corresponding to the target labeling task is present comprises: obtaining a set of historical automatic labeling procedures, wherein each historical automatic labeling procedure of the set of historical automatic labeling procedures corresponds to a task type; and matching the task type of the target labeling task with task types corresponding to the set of historical automatic labeling procedures to identify a matched historical automatic labeling procedure in the set of historical automatic labeling procedures. In some embodiments, determining, based on the task type of the target labeling task, whether an existing automatic labeling procedure corresponding to the target labeling task is present further comprises: if no matched historical automatic labeling procedure is identified, assigning the automatic labeling data to the manual labeling data.

In certain embodiments, determining whether the existing labeling procedure satisfies the first quality evaluation index comprises: extracting a preset quality inspection ratio of data from the automatic labeling data and setting the preset quality inspection ratio of data as quality inspection data; labeling the quality inspection data using the existing labeling procedure; obtaining a result of labeling the quality inspection data by the existing automatic labeling procedure and a result of manual labeling the quality inspection data; determining whether the existing automatic labeling procedure satisfies the first quality evaluation index based on the result of labeling the quality inspection data by the existing automatic labeling procedure and the result of manual labeling the quality inspection data.

In some embodiments, the first quality evaluation index comprises a recall rate, a precision rate, an accuracy rate, a false positive rate and a false negative rate; and wherein determining whether the existing automatic labeling procedure satisfies the first quality evaluation index based on the result of labeling the quality inspection data by the existing automatic labeling procedure and the result of manual labeling the quality inspection data comprises: computing the recall rate, the precision rate, the accuracy rate, the false positive rate and the false negative rate based on the result of labeling the quality inspection data by the existing automatic labeling procedure and the result of manual labeling the quality inspection data; determining whether the existing automatic labeling procedure satisfies the first quality evaluation index based on whether the recall rate, the precision rate, the accuracy rate, the false positive rate and the false negative rate are respectively greater than a recall rate threshold, a precision rate threshold, an accuracy rate threshold, a false positive rate threshold and a false negative rate threshold; in case that the recall rate, the precision rate, the accuracy rate, the false positive rate and the false negative rate are respectively greater than the recall rate threshold, the precision rate threshold, the accuracy rate threshold, the false positive rate threshold and the false negative rate threshold, determining that the existing automatic labeling procedure satisfies the first quality evaluation index; in case that at least one of the recall rate, the precision rate, the accuracy rate, the false positive rate and the false negative rate is not greater than the recall rate threshold, the precision rate threshold, the accuracy rate threshold, the false positive rate threshold and the false negative rate threshold, determining that the existing automatic labeling procedure fails to satisfy the first quality evaluation index.

In certain embodiments, determining whether the existing automatic labeling procedure satisfies the first quality evaluation index comprises: if the existing automatic labeling procedure satisfies the first quality evaluation index, labeling the automatic labeling data with the existing automatic labeling procedure. In some embodiments, obtaining the set of automatic labeling procedures based on the task type of the target labeling task comprises: selecting, based at least in part on a predefined feature extraction model criteria and a classifier model criteria, X feature extraction models and Y classifier models respectively based on the task type of the target labeling task, X and Y being positive integers; obtaining a set of automatic labeling procedures from permutating and combining any one feature extraction model of the X feature extraction models with any one classifier model of the Y classifier models.

In certain embodiments, computing labeling quality and labeling metric of each automatic labeling procedure in the set of automatic labeling procedures comprises: extracting quality inspection data from the labeling data, the quality inspection data is a part of the labeling data; labeling the quality inspection data respectively with each automatic labeling procedure in the set of automatic labeling procedures; computing labeling quality of each automatic labeling procedure in the set of the automatic labeling procedures based on a result of labeling the quality inspection data by each automatic labeling procedure in the set of the automatic labeling procedures and the result of manual labeling the quality inspection data; obtaining task characteristics of the target labeling task, the task characteristics including quantity of data items of the automatic labeling data and an average cost for manually labeling a single data item of the automatic labeling data; computing labeling metric of each automatic labeling procedure in the set of the automatic labeling procedures respectively based on the task characteristics and the result of labeling the quality inspection data by each of the automatic labeling procedures. In certain embodiments, computing labeling quality of each automatic labeling procedure in the set of the automatic labeling procedures comprises: computing the recall rate, the precision rate, the accuracy rate and a ratio of correctly identified negatives of each automatic labeling procedure in the set of the automatic labeling procedures respectively based on the result of labeling the quality inspection data by each of the automatic labeling procedures and the result of manual labeling the quality inspection data; obtaining labeling quality of each automatic labeling procedure in the set of the automatic labeling procedures through linear weighting of the recall rate, the precision rate, the accuracy rate and the ratio of correctly identified negatives.

In certain embodiments, determining the first automatic labeling procedure based on the labeling quality and the labeling metric comprises: computing a Pareto dominance relation between any two automatic labeling procedures in the set of the automatic labeling procedures based on the labeling quality and the labeling metric; determining the first automatic labeling procedure based on the Pareto dominance relation. In some embodiments, computing Pareto dominance relation between any two automatic labeling procedures in the set of the automatic labeling procedures based on the labeling quality and the labeling metric comprises: establishing a set of labeling qualities and a set of labeling metrics corresponding to the set of automatic labeling procedures; obtaining a first labeling metric of a first automatic labeling procedure in the set of automatic labeling procedures; determining whether the first labeling metric is smaller than or equal to a labeling metric threshold; if the first labeling metric is smaller than the labeling metric threshold, traversing the set of labeling qualities and the set labeling metrics to calculate Pareto dominance relation between any two automatic labeling procedures in the set of the automatic labeling procedures.

In certain embodiments, determining the first automatic labeling procedure based on the Pareto dominance relation comprises: computing one or more second numbers corresponding to the set of automatic labeling tasks by at least: for each automatic labeling procedure in the set of automatic labeling procedures, computing a second number of rest automatic labeling procedures dominated by each automatic labeling procedure in the set of the automatic labeling procedures based on the Pareto dominance relation, where the rest automatic labeling procedures include remaining automatic labeling procedures after selecting any one of the automatic labeling procedure from the set of automatic labeling procedures; sorting a priority of the set of automatic labeling procedures based on the one or more second numbers; determining the first automatic labeling procedure as an automatic labeling procedure with the highest second number in the one or more second numbers.

In some embodiments, determining whether the first automatic labeling procedure satisfies the first quality evaluation index comprises: extracting quality inspection data from the labeling data, the quality inspection data is a part of the labeling data; labeling the quality inspection data with the first automatic labeling procedure; determining whether the first automatic labeling procedure is greater than a quality control threshold of the first quality evaluation index based on a result of labeling the quality inspection data by the first automatic labeling procedure and the result of manual labeling the quality inspection data; if the first automatic labeling procedure is greater than the quality control threshold, determining that the first automatic labeling procedure satisfies the first quality evaluation index; if the first automatic labeling procedure is not greater than the quality control threshold, determining that the first automatic labeling procedure fails to satisfy the first quality evaluation index.

In certain embodiments, determining that the first automatic labeling procedure fails to satisfy the first quality evaluation index further comprises: assigning the automatic labeling data of the target labeling task as unlabeled data; updating the first automatic labeling procedure until a Pareto target value of the first automatic labeling procedure converges, wherein the unlabeled data are performed with following extraction and labeling operations comprising: performing random extraction on the unlabeled data to obtain randomly extracted data; computing a contribution value of respective data items in the randomly extracted data to a multi-objective optimization model, the multi-objective optimization model being provided for computing a first Pareto optimal target value of the first automatic labeling procedure; selecting data items from the randomly extracted data based on contribution values of the respective data items in the randomly extracted data, to form extraction data with high contribution value; manually labeling the extraction data with a high contribution value to obtain a corresponding manual labeling result; computing a second Pareto optimal target value of the first automatic labeling procedure based on the extraction data with the high contribution value and the corresponding manual labeling result; updating the first automatic labeling procedure based on the extraction data with the high contribution value and the corresponding manual labeling result; and updating the unlabeled data based on the extraction data with the high contribution value and the corresponding manual labeling result; and continuing to perform the extraction and labeling operations based on the unlabeled data updated until the second Pareto target value converges.

The above description only explains preferred embodiments of the present disclosure and the technical principles applied here. Those skilled in the art should understand that the scope of the present disclosure is not limited to the technical solution consisting of the particular combinations of the above technical features. Meanwhile, the present disclosure also should encompass other technical solutions consisting of any combinations of the above technical feature or other equivalent features without deviating from the above disclosed concept. For example, the above features may substitute with the technical features having similar functions as disclosed here to form a new technical solution.

I/We claim:

1. A method for data labeling, the method comprising:
receiving a data labeling request, the data labeling request including one or more labeling tasks, one or more task types corresponding to the one or more labeling tasks, labeling data, a constraint, one or more labeling index values corresponding to the one or more labeling asks, the labeling data including one or more data items, the constraint including one or more constraint conditions;
determining a target labeling task based on the one or more labeling index values and the one or more labeling tasks;
dividing, based on the constraint, the labeling data of the target labeling task into automatic labeling data and manual labeling data;
determining a labeling procedure based on the data labeling request and at least one selected from a group consisting of the task type, a labeling quality, and a labeling metric; and
labeling the automatic labeling data using the labeling procedure.

2. The method of claim 1, wherein determining the labeling procedure based on the data labeling request and at least one selected from a group consisting of the task type, the labeling quality, and the labeling metric comprises:
determining, based on a task type of the target labeling task, whether an existing labeling procedure corresponding to the target labeling task is present;
if the existing labeling procedure is present, determining whether the existing labeling procedure satisfies a first quality evaluation index; and
if the existing labeling procedure is not present:
obtaining a set of automatic labeling procedures based on the task type of the target labeling task; and
determining, based on the set of automatic labeling procedures, the labeling procedure.

3. The method of claim 2, wherein determining, based on the set of automatic labeling procedures, the labeling procedure comprises:
computing a labeling quality and a labeling metric of each automatic labeling procedure in the set of automatic labeling procedures;
determining a first automatic labeling procedure based on the labeling quality and the labeling metric;
determining whether the first automatic labeling procedure satisfies the first quality evaluation index;
if the first automatic labeling procedure satisfies the first quality evaluation index, setting the first automatic labeling procedure as the labeling procedure.

4. The method of claim 1, wherein determining the target labeling task based on the one or more labeling index values and the one or more labeling tasks comprises:
computing one or more first numbers corresponding to one or more labeling tasks by at least:
for each labeling task in the one or more labeling tasks, computing a first number of a rest of the labeling tasks dominated by the each labeling task based on a corresponding labeling index value of the each labeling task, wherein the rest of the labeling tasks are one or more remaining labeling tasks after selecting a labeling task from the one or more labeling tasks;
sorting a priority of one or more labeling tasks based on the one or more first numbers; and
determining a labeling task with the highest first number in the one or more first numbers as the target labeling task.

5. The method of claim 1, wherein dividing, based on the constraint, the labeling data of the target labeling task into automatic labeling data and manual labeling data comprises:
deciding whether each data item of the one or more data items in the labeling data satisfies each constraint condition of the one or more constraint conditions of the constraint;
assigning one or more data items of the labeling data satisfying the constraint as the automatic labeling data;
assigning one or more data items of the labeling data not satisfying the constraint as the manual labeling data.

6. The method of claim 5, wherein assigning one or more data items of the labeling data not satisfying the constraint as the manual labeling data comprises:
determining a target pre-filter procedure based on a task type of the target labeling task;
determining, respectively, whether each data item of the one or more data items in the manual labeling data satisfies a target pre-filter procedure threshold based on the target pre-filter filter procedure;
sending one or more data items satisfying the target pre-filter procedure threshold to a manual labeling data item queue;
discarding one or more data items not satisfying the target pre-filter procedure threshold.

7. The method of claim 6, wherein determining the target pre-filter procedure according to the task type of the target labeling task comprises:
obtaining a set of pre-filter procedures, wherein each pre-filter procedure in the set of pre-filter procedures corresponds to a task type, and each pre-filter procedure includes discarding negatives in the manual labeling data;
matching the task type of the target labeling task with one or more task types corresponding to the set of pre-filter procedures to identifying a matched pre-filter procedure in the set of pre-filter procedures;
assigning the matched pre-filter procedure as the target pre-filter procedure.

8. The method of claim 2, wherein determining, based on the task type of the target labeling task, whether the existing automatic labeling procedure corresponding to the target labeling task is present comprises:
obtaining a set of historical automatic labeling procedures, wherein each historical automatic labeling procedure of the set of historical automatic labeling procedures corresponds to a task type; and
matching the task type of the target labeling task with task types corresponding to the set of historical automatic labeling procedures to identify a matched historical automatic labeling procedure in the set of historical automatic labeling procedures.

9. The method of claim 8, wherein determining, based on the task type of the target labeling task, whether an existing automatic labeling procedure corresponding to the target labeling task is present further comprises:
if no matched historical automatic labeling procedure is identified, assigning the automatic labeling data to the manual labeling data.

10. The method of claim 2, wherein determining whether the existing labeling procedure satisfies the first quality evaluation index comprises:
extracting a preset quality inspection ratio of data from the automatic labeling data and setting the preset quality inspection ratio of data as quality inspection data;
labeling the quality inspection data using the existing labeling procedure;
obtaining a result of labeling the quality inspection data by the existing automatic labeling procedure and a result of manual labeling the quality inspection data;
determining whether the existing automatic labeling procedure satisfies the first quality evaluation index based on the result of labeling the quality inspection data by the existing automatic labeling procedure and the result of manual labeling the quality inspection data.

11. The method of claim 10, wherein the first quality evaluation index comprises a recall rate, a precision rate, an accuracy rate, a false positive rate and a false negative rate; and
wherein determining whether the existing automatic labeling procedure satisfies the first quality evaluation index based on the result of labeling the quality inspection data by the existing automatic labeling procedure and the result of manual labeling the quality inspection data comprises:
computing the recall rate, the precision rate, the accuracy rate, the false positive rate and the false negative rate based on the result of labeling the quality inspection data by the existing automatic labeling procedure and the result of manual labeling the quality inspection data;
determining whether the existing automatic labeling procedure satisfies the first quality evaluation index based on whether the recall rate, the precision rate, the accuracy rate, the false positive rate and the false negative rate are respectively greater than a recall rate threshold, a precision rate threshold, an accuracy rate threshold, a false positive rate threshold and a false negative rate threshold;
in case that the recall rate, the precision rate, the accuracy rate, the false positive rate and the false negative rate are respectively greater than the recall rate threshold, the precision rate threshold, the accuracy rate threshold, the false positive rate threshold and the false negative rate threshold, determining that the existing automatic labeling procedure satisfies the first quality evaluation index;
in case that at least one of the recall rate, the precision rate, the accuracy rate, the false positive rate and the false negative rate is not greater than the recall rate threshold, the precision rate threshold, the accuracy rate threshold, the false positive rate threshold and the false negative rate threshold, determining that the existing automatic labeling procedure fails to satisfy the first quality evaluation index.

12. The method of claim 2, wherein determining whether the existing automatic labeling procedure satisfies the first quality evaluation index comprises:
if the existing automatic labeling procedure satisfies the first quality evaluation index, labeling the automatic labeling data with the existing automatic labeling procedure.

13. The method of claim 2, wherein obtaining the set of automatic labeling procedures based on the task type of the target labeling task comprises:
selecting, based at least in part on a predefined feature extraction model criteria and a classifier model criteria, X feature extraction models and Y classifier models respectively based on the task type of the target labeling task, X and Y being positive integers;
obtaining a set of automatic labeling procedures from permutating and combining any one feature extraction model of the X feature extraction models with any one classifier model of the Y classifier models.

14. The method of claim 3, wherein computing labeling quality and labeling metric of each automatic labeling procedure in the set of automatic labeling procedures comprises:
extracting quality inspection data from the labeling data, the quality inspection data is a part of the labeling data;
labeling the quality inspection data respectively with each automatic labeling procedure in the set of automatic labeling procedures;
computing labeling quality of each automatic labeling procedure in the set of the automatic labeling procedures based on a result of labeling the quality inspection data by each automatic labeling procedure in the set of the automatic labeling procedures and the result of manual labeling the quality inspection data;
obtaining task characteristics of the target labeling task, the task characteristics including quantity of data items of the automatic labeling data and an average cost for manually labeling a single data item of the automatic labeling data;
computing labeling metric of each automatic labeling procedure in the set of the automatic labeling procedures respectively based on the task characteristics and the result of labeling the quality inspection data by each of the automatic labeling procedures.

15. The method of claim 14, wherein computing labeling quality of each automatic labeling procedure in the set of the automatic labeling procedures comprises:
computing the recall rate, the precision rate, the accuracy rate and a ratio of correctly identified negatives of each automatic labeling procedure in the set of the automatic labeling procedures respectively based on the result of labeling the quality inspection data by each of the automatic labeling procedures and the result of manual labeling the quality inspection data;
obtaining labeling quality of each automatic labeling procedure in the set of the automatic labeling procedures through linear weighting of the recall rate, the precision rate, the accuracy rate and the ratio of correctly identified negatives.

16. The method of claim 3, wherein determining the first automatic labeling procedure based on the labeling quality and the labeling metric comprises:
computing a Pareto dominance relation between any two automatic labeling procedures in the set of the automatic labeling procedures based on the labeling quality and the labeling metric;
determining the first automatic labeling procedure based on the Pareto dominance relation.

17. The method of claim 16, wherein computing Pareto dominance relation between any two automatic labeling procedures in the set of the automatic labeling procedures based on the labeling quality and the labeling metric comprises:
establishing a set of labeling qualities and a set of labeling metrics corresponding to the set of automatic labeling procedures;
obtaining a first labeling metric of a first automatic labeling procedure in the set of automatic labeling procedures;
determining whether the first labeling metric is smaller than or equal to a labeling metric threshold;
if the first labeling metric is smaller than the labeling metric threshold, traversing the set of labeling qualities and the set labeling metrics to calculate Pareto dominance relation between any two automatic labeling procedures in the set of the automatic labeling procedures.

18. The method of claim 16, wherein determining the first automatic labeling procedure based on the Pareto dominance relation comprises:
computing one or more second numbers corresponding to the set of automatic labeling tasks by at least:
for each automatic labeling procedure in the set of automatic labeling procedures, computing a second number of rest automatic labeling procedures dominated by each automatic labeling procedure in the set of the automatic labeling procedures based on the Pareto dominance relation, where the rest automatic labeling procedures include remaining automatic labeling procedures after selecting any one of the automatic labeling procedure from the set of automatic labeling procedures;
sorting a priority of the set of automatic labeling procedures based on the one or more second numbers;
determining the first automatic labeling procedure as an automatic labeling procedure with the highest second number in the one or more second numbers.

19. The method of claim 3, wherein determining whether the first automatic labeling procedure satisfies the first quality evaluation index comprises:
extracting quality inspection data from the labeling data, the quality inspection data is a part of the labeling data;
labeling the quality inspection data with the first automatic labeling procedure;
determining whether the first automatic labeling procedure is greater than a quality control threshold of the first quality evaluation index based on a result of labeling the quality inspection data by the first automatic labeling procedure and the result of manual labeling the quality inspection data;
if the first automatic labeling procedure is greater than the quality control threshold, determining that the first automatic labeling procedure satisfies the first quality evaluation index;
if the first automatic labeling procedure is not greater than the quality control threshold, determining that the first automatic labeling procedure fails to satisfy the first quality evaluation index.

20. The method of claim 19, wherein determining that the first automatic labeling procedure fails to satisfy the first quality evaluation index further comprises:
assigning the automatic labeling data of the target labeling task as unlabeled data;
updating the first automatic labeling procedure until a Pareto target value of the first automatic labeling procedure converges,
wherein the unlabeled data are performed with following extraction and labeling operations comprising:
performing random extraction on the unlabeled data to obtain randomly extracted data;
computing a contribution value of respective data items in the randomly extracted data to a multi-objective optimization model, the multi-objective optimization model being provided for computing a first Pareto optimal target value of the first automatic labeling procedure;
selecting data items from the randomly extracted data based on contribution values of the respective data items in the randomly extracted data, to form extraction data with high contribution value;
manually labeling the extraction data with a high contribution value to obtain a corresponding manual labeling result;
computing a second Pareto optimal target value of the first automatic labeling procedure based on the extraction data with the high contribution value and the corresponding manual labeling result;
updating the first automatic labeling procedure based on the extraction data with the high contribution value and the corresponding manual labeling result; and updating the unlabeled data based on the extraction data with the high contribution value and the corresponding manual labeling result; and
continuing to perform the extraction and labeling operations based on the unlabeled data updated until the second Pareto target value converges.

21. An electronic device, comprising:
one or more memories comprising instructions stored thereon; and
one or more processors configured to execute the instructions and perform operations comprising:
receiving a data labeling request, the data labeling request including one or more labeling tasks, one or more task types corresponding to the one or more labeling tasks, labeling data, a constraint, one or more labeling index values corresponding to the one or more labeling asks, the labeling data including one or more data items, the constraint including one or more constraint conditions;
determining a target labeling task based on the one or more labeling index values and the one or more labeling tasks;
dividing, based on the constraint, the labeling data of the target labeling task into automatic labeling data and manual labeling data;
determining a labeling procedure based on at least one selected from a group consisting of the task type, a labeling quality, and a labeling metric; and
labeling the automatic labeling data using the labeling procedure.

22. A non-transitory computer readable storage medium stored instructions thereon, the instructions, when executed by one or more processors, cause the one or more processors to perform operations comprising:
receiving a data labeling request, the data labeling request including one or more labeling tasks, one or more task types corresponding to the one or more labeling tasks, labeling data, a constraint, one or more labeling index values corresponding to the one or more labeling asks, the labeling data including one or more data items, the constraint including one or more constraint conditions;
determining a target labeling task based on the one or more labeling index values and the one or more labeling tasks;
dividing, based on the constraint, the labeling data of the target labeling task into automatic labeling data and manual labeling data;
determining a labeling procedure based on at least one selected from a group consisting of the task type, a labeling quality, and a labeling metric; and
labeling the automatic labeling data using the labeling procedure.
